(19) United States
(12) Patent Application Publication
(10) Pub. No.: US 2002/0155328 A1
(43) Pub. Date: Oct. 24, 2002

(54) Method and apparatus for water vapor transfer

(76) Inventors: T. Paul Smith, Oakhurst, NJ (US); David A. Leighty, Beachwood, NJ (US)

Correspondence Address: ROBERT M. SKOLNIK, 353 Monmouth Road, PO Box 22, West Long Branch, NJ, 07764-0022, US

(21) Appl. No.: 09/839,748

(22) Filed: Apr. 20, 2001

(51) Int. Cl. H01M 8/04

(52) U.S. Cl. 429/13; 429/26

(57) ABSTRACT

In humidifying the fuel input to a fuel cell, a stream of dry inlet gas is passed inside the strands of liquid permeable tubes. A stream of hot wet exhaust gas from the fuel cell or hot cooling water from the fuel cell is passed over the outside of the tubing bundle in a counter-current flow direction. Water vapor from the hot wet exhaust gas or liquid water from the hot cooling water is absorbed onto the outside surface of the permeable tubing, permeates through the walls of the tubing, and pervaporates into the dry gas stream inside the tubing. At the same time, heat from the exhaust gas or cooling water is conducted through the tubing walls into the dry gas stream inside. The permeation of water also carries heat with it, increasing the efficiency of heat recovery and transfer into the inlet fuel/oxidant gas.

### BACKGROUND OF THE INVENTION

1. Field of the Invention

The present invention relates to membrane tubing humidifiers and specifically to such humidifiers used with fuel cells.

2. Description of the Related Art

Commonly assigned U.S. Pat. Nos. 3,735,558, 4,705,542, and 4,808,201 disclose and claim devices having tubes whose construction is of materials selected so that the humidity and temperature of the gases flowing through the tubes are equalized to those of the gases surrounding the outside of the tube.

The tubes are formed of extrudable plastic materials, which selectively permit water vapor to diffuse through the walls of the tube but inhibit the ability of other gases from so diffusing. The water vapor diffuses through the walls of the tube from the side of higher concentration to that of lower concentration level. A difference in total pressure between the inside and outside of the tubing is not required, only a difference in the water concentration. In practice, when highly humid gas is sampled, the water vapor in the sample diffuses through the tubing wall out into the surrounding dry air or gas. Circulation of a surrounding dry air or gas permits continuous operation of the process. Thus, condensation in the sampling tube is prevented from occurring, and the problems occasioned by such condensation are eliminated. Because of extreme selectivity in the process, only water is removed, not other gases of interest.

Fuel cells produce electricity directly from the chemical combination of fuel with oxygen, resulting in more efficient use of the fuel than traditional generating methods that combust the fuel then use the resultant heat to generate electricity. Fuel cells also have much lower environmental impact than traditional generating methods because fuel cell exhaust consists only of air and water vapor with little waste heat loss.

In the fuel cells of the present invention, the process involves reaction of a fuel, typically hydrogen, with oxygen. A chamber of hydrogen with water vapor is separated from a chamber of oxygen by a membrane. The membrane is formed of NAFION® polymer manufactured by DuPont or some similar ion-conductive polymer. NAFION polymer is highly selectively permeable to water when exposed to gases. Both sides of the NAFION membrane are coated with a catalyst ink. The catalyst ink is typically liquid NAFION (i.e. NAFION that has been solubilized by treatment with alcohol under high pressure and temperature) containing carbon particles (soot) coated with platinum particles. The liquid NAFION ink is applied to both sides of the membrane, and, when it dries, it makes ion-conductive contact between the membrane and the particles within the ink. Hydrogen adsorbs onto the platinum particles and separates into hydrogen atoms. Then, the hydrogen atom reacts with a water molecule to form an hydronium ion (H3O+) and a free electron (e−). Two hydronium ions permeate through the NAFION membrane, then react with an oxygen atom that has formed by adsorption of an oxygen molecule onto the surface of the catalyst on the opposite side of the membrane. Water is formed and an electrical potential of 0.7 electron volts is created. The electrons left behind are conducted to the oxygen side, completing the circuit. A relatively small amount of heat is released; the energy of the reaction is instead efficiently converted directly to electricity.

An arbitrarily high voltage can be created by combining successive layers of membrane electrode assemblies (“MEA”). An arbitrarily high current can be generated by increasing the surface area of each MEA and providing sufficient fuel and oxidant. The catalysts and membrane are unchanged by the reaction, so all that is consumed is hydrogen and water on one side of the membrane and oxygen on the other. Water must be continuously added to the hydrogen for the cell to function normally.

Although the fuel in a simple fuel cell is hydrogen, it is possible to produce hydrogen from traditional fuels (propane or natural gas) by a process called reforming. While reforming consumes some energy, it permits existing fuel supplies to be used to power fuel cells. Other existing fuel cell cycles use methanol or other compounds directly as a fuel rather than hydrogen.

Fuel cells release more water in their exhaust than they require in their fuel (three molecules are released for every two consumed). Since water permeates very readily through the membrane separating the fuel and oxidant, sufficient water can return from the oxygen side of the membrane to the fuel (hydrogen) side by simple permeation as long as the high water concentration on the oxidant side is maintained.

Fuel cells often operate using air as the oxidant, relying upon the ca. 20% oxygen in ambient air, obviating the need for a separate oxidant supply. The use of air as an oxygen source requires a flow rate of air five times that required for oxygen. When ambient air is used as an oxygen source, this high flow rate dries out the membrane by diluting the water concentration on the oxidant (exhaust) side of the membrane.

If water can be recovered from the exhaust, the need for a separate water supply to keep the membrane hydrated for proper permeation of hydrogen is eliminated. The present invention is a method and apparatus, which recovers and recycles water from the exhaust and returns it to the inlet gases for fuel cells.

Fuels cells are characterized by simplicity of operation, reliability (having few moving parts), low maintenance (pumps must be maintained and fuel supplied), and are compact and lightweight (compared to other sources of electricity (other than solar cells).

Until recently, fuel cells were prohibitively expensive except for specialty uses where size, weight, and reliability were paramount (aerospace). The expensive parts are the catalysts and the membranes due to the high cost of precious metal catalysts (such as platinum) and ion-exchange membranes (such as NAFION). A breakthrough occurred when platinum coating on carbon particles was substituted for simple platinum particles in the catalyst “ink”. A second advancement involved the inclusion of very thin NAFION membranes supported by a porous backing. Fuel cells are now or soon will be competitive with traditional methods of electricity in many applications, including power generation, transportation, and portable power sources.

Fuel cells are used for stationary power generation in remote locations where installation of transmission lines and losses during transmission increase the cost of centralized electricity production. Fuel cells are also used for backup power for hospitals and other facilities that cannot tolerate a temporary failure in electrical supply. Fuel cells are more reliable that traditional diesel back-up generators.

Transportation is the largest man-made contributor to air pollution and concomitant global warming through the release of carbon dioxide, as well as other exhaust components such as nitrogen oxides, partially combusted hydrocarbons, soot, etc. Fuel cells release only water and much less heat.

As fuel cells can be scaled down to very small size, they will eventually replace batteries in devices such as laptop computers and cell phones.

### SUMMARY OF THE INVENTION

The larger of the fuel cells described above require humidification of the gases in order to operate efficiently. Various approaches to humidification of fuel cells involve desiccant wheels, monoliths, molecular sieve stacks, etc., which involve moving parts and often create leaks at the seals when hydrogen is introduced.

The present invention is a method and apparatus for humidifying fuel cell gases by permeation of liquid water through the tubing walls into the fuel cell inlet gases. The method and apparatus of the present invention is highly efficient so that the cost of the fuel cell is reduced. The method and apparatus can also be used to recycle the water from the exhaust gases into the fuel gases.

The principal object and advantage of the invention is the provision of a method and apparatus for humidification in fuel cells that uses no moving parts.

Another object and advantage of the method and apparatus of the present invention is humidification in fuel cells without using energy.

A still further object and advantage of the method and apparatus of the present invention is the provision of a method and apparatus for humidification in fuel cells that has high corrosion resistance so that it is unaffected by de-ionized water or fuel and exhaust gases.

Another object and advantage of the method and apparatus of the present invention is the provision of a method and apparatus for humidification in fuel cells that meets temperature and pressure tolerance requirements.

A still further object and advantage of the method and apparatus of the present invention is the provision of a method and apparatus for humidification in fuel cells that contributes a pressure drop that is acceptable.

A further object and advantage of the method and apparatus of the present invention is the provision of a method and apparatus for humidification in fuel cells that is compact.

A still further object and advantage of the method and apparatus of the present invention is the provision of a method and apparatus for humidification in fuel cells that is characterized by lightweight.

An important object and advantage of the method and apparatus of the present invention is the provision of a method and apparatus for humidification in fuel cells that does not contaminate the gases with dissolved ions or particles that may damage the NAFION membranes in the fuel cell.

A still further object and advantage of the method and apparatus of the present invention is the provision of a method and apparatus for humidification in fuel cells that meets high humidification requirements.

An important object and advantage of the method and apparatus of the present invention is the provision of a method and apparatus for humidification in fuel cells that contributes zero mixing between the two gas streams (fuel and exhaust).

Another object and advantage of the method and apparatus of the present invention is the provision of a method and apparatus for humidification in fuel cells that efficiently recycles water from the exhaust to the inlet gases.

A still further object and advantage of the method and apparatus of the present invention is the provision of a method and apparatus for humidification in fuel cells that provides the function of heat exchange as well as moisture exchange so both waste heat and water are recovered from the exhaust.

### BRIEF DESCRIPTION OF THE DRAWINGS

These as well as further objects and advantages of the invention will become apparent to those skilled in the art from a review of the following detailed specification reference being made to the accompanying drawings in which:

FIG. 1 is a diagrammatic view of the apparatus of the present invention connected to a fuel cell used for gas-to-gas moisture exchange;

FIG. 2 is a diagrammatic view of the apparatus of the present invention connected to a fuel cell used for liquid-to-gas moisture exchange;

FIG. 3 is an exploded view of the end fitting connection for the apparatus of the present invention;

FIG. 4 is a sectional view of the apparatus of the present invention;

FIG. 5 is a graph showing test results of the method and apparatus of the present invention; and

FIG. 6, is another graph showing test results of the method and apparatus of the present invention.

### DETAILED DESCRIPTION OF THE INVENTION

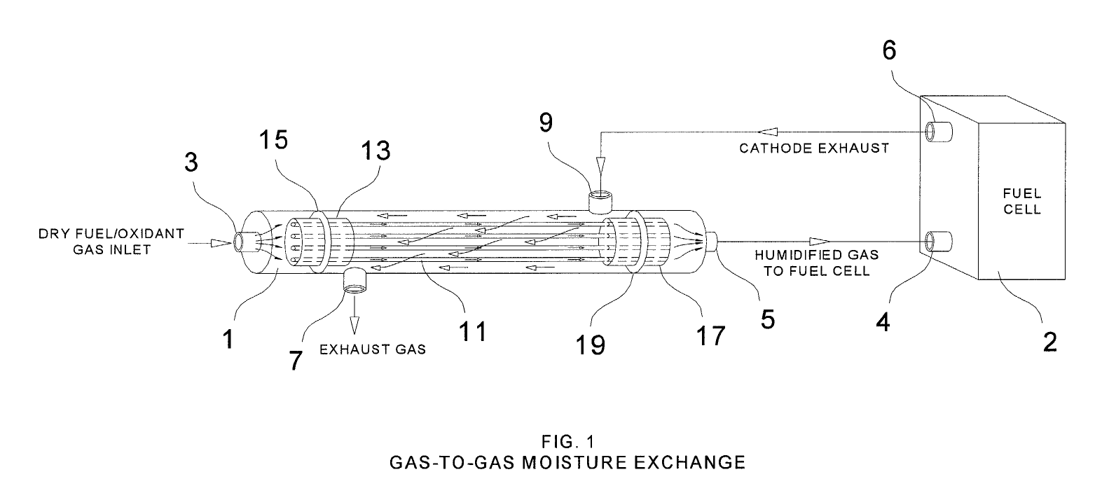

FIG. 1 is a diagrammatic view of method and the apparatus of this invention. A fuel cell (2) has an input (4) and an output (6). Humidified gas is provided to the fuel cell via input (4). Exhaust gas from the fuel cell is provided from output (6). In the embodiment of FIG. 1, the moisture in the exhaust from the fuel cell output (6) is re-used. The output (6) is connected to input (9) of a humidifier of the type generally described in the aforementioned U.S. Pat. Nos. 3,735,558, 4,705,542, and 4,808,201.

The humidifier includes a tubular housing (1) having an inlet port (3) at one end thereof and an outlet port (5) at the opposite end thereof. A plurality of liquid-permeable tubes (11) is mounted in the housing (1) by embedding the opposite ends of the tubes in headers (13 and 17). The headers (13 and 17) are mounted within the housing (1). The periphery of each header is sealed by respective seals (15) (for header 13) and (19) (for header 17). An exhaust gas outlet (7) is also provided.

In operation, dry fuel/oxidant is connected to the inlet port (3). The gas passes through the tubes (11) and then to the output port (5). The fuel/oxidant in the permeable tubes (11) is humidified and heated by exchange of the moisture and heat in the exhaust gas from the fuel cell (2). After passing over the permeable tubes (11), this exhaust gas is removed via the exhaust port (7).

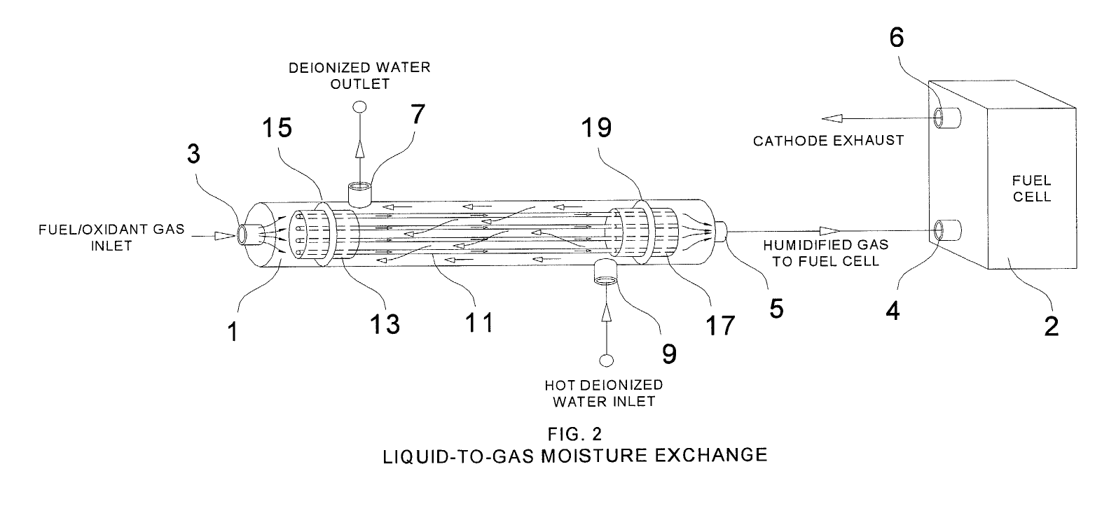

FIG. 2 is another embodiment of the method and apparatus of this invention. Like numerals have been used to designate like parts in FIGS. 1 and 2. In FIG. 2, the exhaust gas from the fuel cell at outlet port (6) is not used as a source of heat and moisture. Instead the fuel/oxidant is humidified and heated by exchange of moisture and heat from hot de-ionized water flowing over the permeable tubes (11). More particularly, in FIG. 2, liquid is connected to the inlet (13) and removed at the outlet (7) after passing around the permeable tubes (11). Cooling water from the fuel cell assembly is typically used as a source of hot de-ionized water, once again recovering heat from the process.

In both FIGS. 1 and 2, a stream of dry inlet gas is passed inside the strands of the permeable tubes (11). A stream of hot wet exhaust gas (FIG. 1) or hot cooling water (FIG. 2) is passed over the outside of the tubing bundle in a counter-current flow direction. Water vapor from the hot wet exhaust gas or liquid water from the hot cooling water is absorbed onto the outside surface of the permeable tubing, permeates through the walls of the tubing, and pervaporates into the dry gas stream inside the tubing. At the same time, heat from the exhaust gas or cooling water is conducted through the tubing walls into the dry gas stream inside. The permeation of water also carries heat with it, increasing the efficiency of heat recovery and transfer into the inlet fuel/oxidant gas.

The humidifier is a passive device. There are no moving parts. There are no materials consumed during operation and no routine maintenance is required. No energy is consumed in its operation when the source of moisture is wet exhaust gas. If liquid water (from cooling water or another source) is used as the source of moisture (as in FIG. 2), then energy is consumed as heat-of-vaporization as water moves from the liquid phase to the vapor phase. If cooling water is used, there is sufficient excess heat from the fuel cells to provide this heat with no additional source of energy.

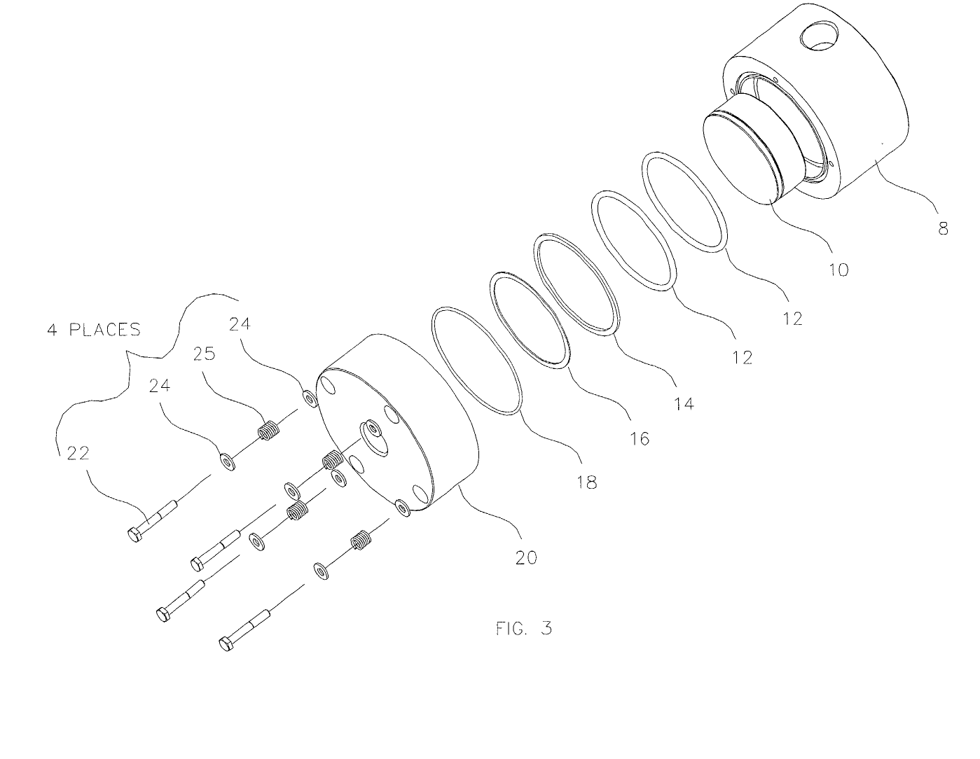

FIG. 3 is an exploded view of the end fitting connection for the apparatus of the present invention. This end fitting connection is used to mount and support both ends of the permeable tube bundle (11) described in connection with FIGS. 1 and 2. In FIG. 3, the ends of the permeable tubes are embedded in a header plug (10). The plug is mounted in an end fitting (8). Two adjoining O-rings (12) seat into a recess on the inside diameter in the end of the end fitting (8) to seal the header plug (10) into the end fitting (8). A gland cover ring (14) sits atop the inner edge of the end fitting (8), and the gland cover ring covers the recess holding the two O-rings (12) described above. The gland cover ring provides a contact surface for a retaining ring (16) to press against, holding the header plug in place. The retaining ring (16) fits into a groove machined into the header plug (10). Another O-ring (18) is seated into a groove cut into the face of the end fitting (8). The end cap (20) is bolted to the end fitting (8) with bolts (22) and washers (24). A seal is made by compression of the O-ring (18) between the faces of the end fitting (8) and the end cap (20).

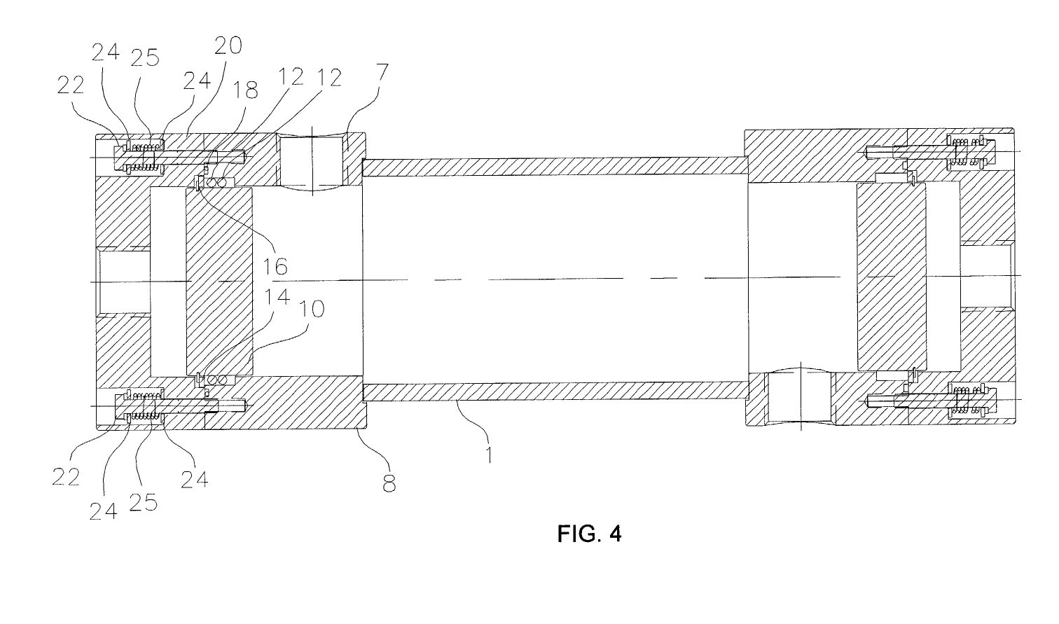

FIG. 4 is a cross sectional assembly view of the apparatus of FIGS. 1-3. As shown in FIG. 4, the housing (1) is mounted over a portion of the header plug (10), mating by welding with a notch formed in the end fitting (8). The end fitting (8) surrounds most of the remainder of plug (10). The header plug (10) is sealed into the end fitting (8) by the two adjoining O-rings (12). The end fitting (18) is sealed to the end cap (20) by the O-ring (18) in the groove between the faces of these two parts. The end cap (20) is bolted to the end fitting (8) using four bolts (22) and washers(24). The gland cover ring (14) sits atop the edge of the end fitting (8). The gland cover ring does not interfere with the face sealing O-ring (18). The retaining ring (16) fits into a groove machined into the header plug (10) and is trapped between the gland cover ring (14) and the end cap (20). This position holds the header plug (10) firmly in place.

The fuel/oxidant inlet port (3) or outlet port (5) (the ends are identical) is welded to the end cap (20). The fuel cell exhaust gas input or fuel cell cooling water input (9) (depending upon whether this is a gas-to-gas or water-to-gas moisture exchange, described in connection with FIGS. 1 and 2) is welded to the side of the housing (1). The exhaust for this input (7) would be in the same position as the inlet port (9) but on the opposite end.

The method of the present invention has been tested. The following examples demonstrate the effectiveness of the method of this invention.

### EXAMPLE 1

A humidifier unit was tested for liquid-to-gas moisture exchange. The humidifier tested was a 504-tube device with a nominal length of 48″. Each membrane tube was 0.060″ O.D.×0.0055″ wall thickness. A portion of each tube was imbedded in casting resin at each end which reduced the active length of each tube to ˜44″. This leaves an active surface area of ˜2.42 ft².

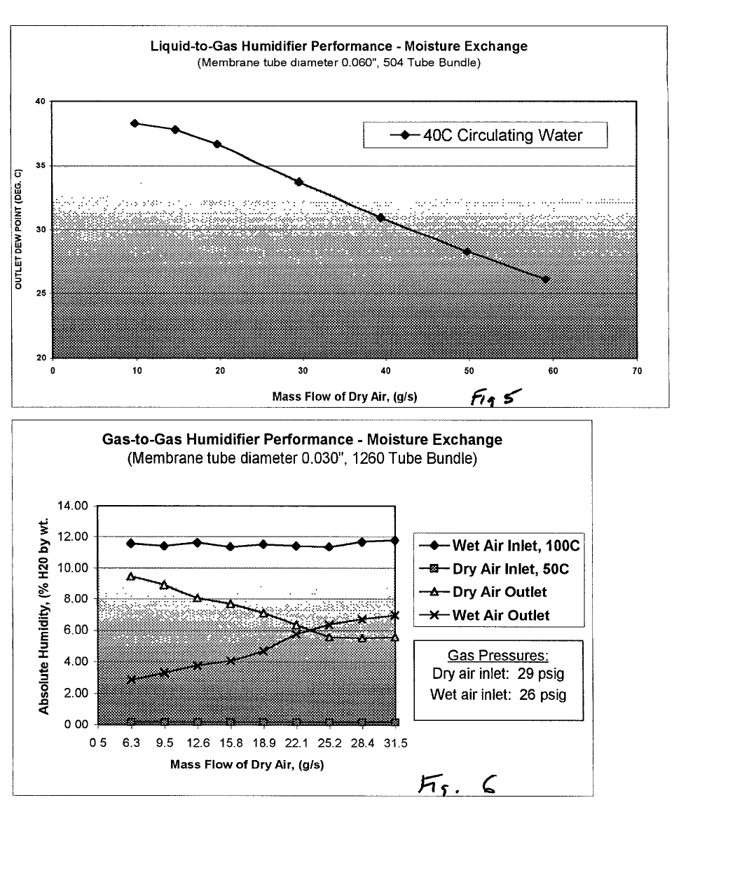

The test was performed by passing dry air into the tube side of the device. Hot de-ionized water was circulated in a closed loop on the shell side of the device at 40° C. to provide the necessary heat energy. The water flow in the shell was sufficiently high as to not hinder the humidification performance and was counter-current to the dry airflow in the tubes. Water was added to the loop continually from a reservoir to make up for the water consumed by the device. The graph of FIG. 5 shows the humidity level at the outlet of the tube side of the device.

### EXAMPLE 2

A humidifier unit was tested for gas-to-gas moisture exchange. The unit tested was a 1260 tube device with a nominal length of 24″. Each membrane tube was 0.033″ O.D.×0.0045″ wall thickness. A portion of each tube was imbedded in casting resin at each end which reduced the active length of each tube to ˜20″. This leaves an active surface area of ˜1.51 ft².

The test was performed by passing dry air into the tube side of the device. Hot humidified air was passed into the shell side of the device at a mass flow of 90% of the dry air mass flow (measured on a dry basis) and counter-current to the dry airflow. The graph in FIG. 6 shows the humidity levels at the four ports of the device.

As modifications to the foregoing may be made without departing from the spirit and scope of our invention, what is sought to be protected is set forth in the appended claims.

We claim:

1. The method of humidifying the fuel or oxidant gas for a fuel cell comprising the steps of:
a. passing a fuel or oxidant gas for a fuel cell through a plurality of liquid-permeable tubes, then;
b. passing hot humidified gas over said liquid-permeable tubes whereby said fuel or oxidant gas is humidified and heated by said humidified gas.

2. The method of claim 1 wherein said hot humidified gas is the exhaust gas from a fuel cell.

3. The method of humidifying the fuel or oxidant gas for a fuel cell comprising the steps of;
a. passing a fuel or oxidant gas for a fuel cell through a plurality of liquid-permeable tubes, then;
b. passing hot water over said liquid-permeable tubes, whereby said fuel or oxidant gas is humidified and heated by said liquid.

4. The method of claim 2 wherein said hot water is the cooling water from a fuel cell.

5. In combination; a fuel cell having an input and an exhaust gas output; means for producing humidified gas connected to said input, and means connected to said exhaust gas output and to said means for producing humidified gas for re-using the moisture in said exhaust gas in the production of said humidified gas.

6. The combination of claim 5 further including a humidifier, said humidifier including a tubular housing having an inlet port and an outlet port therein; a plurality of liquid-permeable tubes mounted in said housing, said tubes having their opposite ends being embedded in header means for supporting said tubes, and sealing means connected to the periphery of each of said header means for sealing said header means in said housing.

7. The method of humidifying a fuel cell comprising the steps of, conveying dry fuel/oxidant to a humidifier; conveying wet exhaust gas from a fuel cell to said humidifier, passing said dry/fuel oxidant through liquid-permeable tubes in said humidifier; passing said wet exhaust gas over said liquid-permeable tubes in said humidifier for humidifying and heating said dry/fuel oxidant by exchange of the moisture and heat from said exhaust gas; and removing said exhaust gas from said humidifier.

8. Apparatus for humidifying a fuel cell comprising; a fuel cell having an input; a humidifier having at least two inputs and at least two outputs; a source of fuel oxidant gas connected to one of said inputs and means connected to receive said fuel oxidant gas for conveying said fuel oxidant gas through liquid-permeable tubes in said humidifier; one of said outputs being connected to the input of said fuel cell for conveying fuel oxidant gas to said fuel cell after said fuel oxidant gas passed through said liquid-permeable tubes in said humidifier; and a source of hot de-ionized liquid connected to the other of said inputs and means connected to receive said hot de-ionized liquid for conveying said hot de-ionized liquid around liquid-permeable tubes in said humidifier, said hot de-ionized liquid being connected to the other of said outputs for removal from said humidifier;

9. The apparatus of claim 8 wherein said hot de-ionized liquid is cooling water from said fuel cell.

10. The method of humidifying a fuel cell comprising the steps of; conveying dry fuel/oxidant to a humidifier; conveying cooling liquid from a fuel cell to said humidifier, passing said dry/fuel oxidant through liquid-permeable tubes in said humidifier; passing cooling liquid over said liquid-permeable tubes in said humidifier for humidifying and heating said dry/fuel oxidant by exchange of the moisture and heat from said cooling liquid; and removing said cooling liquid from said humidifier.

11. The method of humidifying the input to a fuel cell comprising the steps of: passing a stream of dry inlet gas inside liquid permeable tubes; passing a stream of hot wet exhaust gas from a fuel cell or hot cooling water from a fuel cell over the outside of said liquid permeable tubes in a counter-current flow direction; whereby water vapor from said hot wet exhaust gas or liquid water from said hot cooling water is absorbed onto said liquid permeable tubes, permeates through the walls of said tubing, and pervaporates into said dry inlet gas inside the tubing.

12. The method of claim 11 whereby heat from said hot wet exhaust gas or liquid cooling water is conducted through said liquid permeable tubing into said the dry inlet gas inside the tubing.
